(19) United States
(12) Patent Application Publication
(10) Pub. No.: US 2024/0384142 A1
(43) Pub. Date: Nov. 21, 2024

(54) (METH)ACRYLATE-BASED TOUGHENED ADHESIVES

(71) Applicant: Henkel AG & Co. KGaA, Duesseldorf (DE)

(72) Inventors: Jianping Liu, South Glastonbury, CT (US); Kevin J. Welch, Wallingford, CT (US); Jiangbo Ouyang, Wallingford, CT (US)

(21) Appl. No.: 18/787,377

(22) Filed: Jul. 29, 2024

Related U.S. Application Data
(63) Continuation of application No. PCT/US2023/011846, filed on Jan. 30, 2023.
(60) Provisional application No. 63/304,109, filed on Jan. 28, 2022.

(51) Int. Cl. C09J 133/12; C09J 11/06

(52) U.S. Cl. CPC C09J 133/12; C09J 11/06

(57) ABSTRACT

Structural adhesives containing a core-shell toughening component miscible in methylacrylic-based adhesives in addition to at least one toughening agent which is not miscible in methacrylic adhesives, produced surprisingly improved impact resistance, particularly side impact testing.

### TECHNICAL FIELD

The present disclosure relates to (meth)acrylate-based adhesive compositions which include a toughening agent soluble and/or miscible in (meth)acrylates and which toughening agent provides an increase in impact toughness performance.

### BACKGROUND ART

Current structural adhesives contain various tougheners to increase their performance with respect to impact resistance. Some of the more common toughener additives which have proved to be useful to improve performance characteristics including impact resistance, include butadiene-styrene solid rubber particles such as those sold under the commercially available Blendex brand. Another known and useful toughener is Kraton D 1155, described by its manufacturer (Kraton Corporation), as a linear block copolymer based on styrene and butadiene with bound styrene of 40% mass. Kraton D 1155 is supplied as porous pellets dusted with amorphous silica. Another commercially available useful toughener is Hypro RLP 200X 168 VTM, described by its manufacturer (CVC Thermoset Specialties) as a reactive liquid polybutadiene polymer terminated with methacrylate groups. Although tougheners such as these may enhance performance characteristics, they are not easily dispersible, miscible, or dissolvable in (meth)acrylates and hence suffer from various processability and cost issues. Thus, current (meth)acrylic (e.g. (meth)acrylate) based adhesive compositions which employ these commercially available materials (and others like them) require additional time and expense to ensure that these solid materials are properly incorporated in (meth)acrylates to achieve the desired toughness. For example, failure to ensure proper dispersion of these tougheners in their respective adhesive compositions would be expected to negatively affect the performance properties of the final adhesive compositions.

Thus, it would be particularly advantageous to include a toughener material that can easily be incorporated into (meth)acrylic based adhesives, which is readily miscible and/or dissolvable in (meth)acrylates, and exhibits improved impact resistance. The present invention provides compositions which include toughener materials and toughened compositions which address this problem and provide improved performance properties.

### SUMMARY

An adhesive composition including:
a) a first part including
   i. a (meth)acrylate component;
   ii. about 10% to about 25% by weight of the total composition of a core-shell impact modifier including a polymeric core and at least two polymeric layers surrounding the core, each layer having a different polymer composition from the other layer and, wherein at least one polymeric layer comprises a polymer that is a gradient polymer, the gradient polymer being a copolymer consisting of at least two different monomers (A) and (B) and having a gradient in repeat units arranged from mostly the monomer (A) to mostly the monomer (B) along the copolymer;
   iii. about 10% to about 25% by weight of the total composition of a toughening component selected from the group consisting of polybutadiene rubber particles (Kraton D), a liquid methacrylate-terminated polybutadiene polymer (Hypro RLP) and combinations thereof;
   iv. an amine
b) a second part including:
   i. an epoxy; and
   ii. a peroxide;
      wherein upon cure the composition exhibits at least a 50% increase in side impact strength as compared to the substantially same composition without the impact modifier.

An Adhesive composition including the reaction product of:
a) a first part including
   i. a (meth)acrylate component;
   ii. about 10% to about 25% by weight of the total composition of a core-shell impact modifier including a polymeric core and at least two polymeric layers surrounding the core, each layer having a different polymer composition from the other layer and, wherein at least one polymeric layer comprises a polymer that is a gradient polymer, the gradient polymer being a copolymer consisting of at least two different monomers (A) and (B) and having a gradient in repeat units arranged from mostly the monomer (A) to mostly the monomer (B) along the copolymer;
   iii. about 10% to about 25% by weight of the total composition of a toughening component selected from the group consisting of polybutadiene rubber particles, a liquid methacrylate-terminated polybutadiene polymer and combinations thereof;
   iv. an amine
b) a second part including:
   i. an epoxy; and
   ii. a peroxide;
      wherein upon cure the composition exhibits at least a 50% increase in side impact strength as compared to the substantially same composition without the impact modifier.

### DETAILED DESCRIPTION

The present invention seeks to provide improved toughness properties and especially improved impact resistance properties, by the inclusion of a toughener component which is readily miscible in methacrylate compositions, and which delivers surprising improvements in impact resistance properties. In general, the inventive compositions may include the following components and ranges:

| Component | % Wt Ranges |
|---|---|
| Methyl methacrylate | 20-80%; desirably 30-60%; more desirably |
| | 35-45% |
| Acrylic monomer | 0.05-1%; desirably 0.1-0.5% |
| stabilizer | |
| Curatives | 0.05-5%; desirably 0.5-4% |
| Toughening agents | 10-60%; desirably 20-50%; more desirably |
| | 35-45% |
| Adhesion promoter | 1-30% |
| Rheology modifier | 0.05-10%; desirably 0.1-5% |

In the context of this disclosure, a number of terms shall be utilized.

The term “(meth)acrylate” refers to both or any one of “acrylate” and “methacrylate”.

The term “(meth)acrylic” refers to both or any one of “acrylic” and “methacrylic”.

The term “monomer” refers to a polymer building block which has a defined molecular structure and which can be reacted to form a part of a polymer.

The term “oligomer” refers to a molecule that comprises at least two repeat units.

The term “hydrocarbon or hydrocarbyl group” refers to an organic compound consisting of carbon and hydrogen. Examples of hydrocarbon groups include but are not limited to an alkyl group, such as methyl, ethyl, propyl, butyl, pentyl, hexyl, isopropyl, tertiary butyl, isobutyl and the like; an alkenyl group, such as vinyl, allyl, butenyl, pentenyl, hexenyl and the groups alike; an aralkyl group, such as benzyl, phenethyl, 2-(2,4,6-trimethylphenyl)propyl and the like; or an aryl group, such as phenyl, tolyl, and xylyl, and the like.

The term “optionally substituted” in the term of “optionally substituted hydrocarbon group” means that one or more hydrogens on the hydrocarbon group may be replaced with a corresponding number of substituents preferably selected from halogen, nitro, azido, amino, carbonyl, ester, cyano, sulfide, sulfate, sulfoxide, sulfone, sulfone groups, and the like.

The term “glass transition temperature” refers to a temperature at which a polymer transitions between a highly elastic state and a glassy state. Glass transition temperature may be measured, for example, by differential scanning calorimetry (DSC).

The inventive compositions are generally two-part compositions (Part (A) and Part (B)) as described below, but in some instances may be made into one-part compositions.

### PART (A)

Part (A) includes at least a (meth)acrylic component (such as a methacrylate base material); a toughener component which includes a core-shell impact modifier readily miscible in the methacrylic component, at least one an additional toughening agent and an amine. Other components may be added to Part (A), including stabilizing agents, cure accelerating agents, adhesion promoters, rheology modifiers and other useful materials as described herein.

### (Meth)acrylic Components

The (meth)acrylic component may include any suitable material which contains at least one group having the following formula:

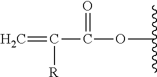

where R is selected from H, halogen, or C₁ to C₁₀ hydrocarbyl, may be used.

Advantageously, the group is a (meth)acryloxy group. The term “(meth)acryloxy” is intended to refer to both acrylate and methacrylate, in which R is H or methyl, respectively. The useful amount of the (meth)acrylic component typically ranges from about 20 percent by weight to about 80 percent by weight of the total composition, desirably in amounts of about 30% to about 60% and more desirably in amounts of about 40% to about 50% by weight of the total composition.

The (meth)acrylic component may be present in the form of a polymer, a monomer, or a combination thereof. When present in the form of a polymer, the (meth)acrylic component may be a polymer chain to which is attached at least one of the above-indicated groups. The groups may be located at a pendant or a terminal position of the backbone, or a combination thereof. Advantageously, at least two such groups may be present, and may be located at terminal 65 positions. The (meth)acrylic component may have a polymer chain, constructed from polyvinyl, polyether, polyester, polyurethane, polyamide, epoxy, vinyl ester, phenolic, amino resin, oil based, and the like, as is well known to those skilled in the art, or random or block combinations thereof.

The polymer chain may be formed by polymerization of vinyl monomers. Illustrative examples of such vinyl monomers are methyl (meth)acrylate, (meth)acrylic acid, ethyl (meth)acrylate, n-propyl (meth)acrylate, isopropyl (meth)acrylate, n-butyl (meth)acrylate, isobutyl (meth)acrylate, tert-butyl (meth)acrylate, n-pentyl (meth)acrylate, n-hexyl (meth)acrylate, cyclohexyl (meth)acrylate, n-heptyl (meth) acrylate, n-octyl (meth)acrylate, 2-ethylhexyl (meth)acrylate, nonyl (meth)acrylate, decyl (meth)acrylate, dodecyl (meth)acrylate, phenyl (meth)acrylate, tolyl (meth)acrylate, benzyl (meth)acrylate, 2-methoxyethyl (meth)acrylate, 3-methoxybutyl (meth)acrylate, 2-hydroxyethyl (meth)acrylate, 2-hydroxypropyl (meth)acrylate, stearyl (meth)acrylate, glycidyl (meth)acrylate, 2-aminoethyl (meth)acrylate, 2-(meth)acryloyloxypropyltrimethoxysilane, (meth)acrylic acid-ethylene oxide adduct, trifluoromethylmethyl (meth)acrylate, 2-trifluoromethylethyl (meth)acrylate, 2-perfluoro-ethylethyl (meth)acrylate, 2-perfluoroethyl-2-perfluorobutylethyl (meth)acrylate, 2-perfluoroethyl (meth)acrylate, perfluoromethyl (meth)acrylate, diperfluoromethylmethyl (meth)acrylate, 2-perfluoromethyl-2-perfluoroethylmethyl (meth)acrylate, 2-perfluorohexylethyl (meth)acrylate, 2-perfluorodecylethyl (meth)acrylate, 2-perfluorohexadecylethyl (meth)acrylate, ethoxylated trimethylolpropane triacrylate, trimethylol propane trimethacrylate, dipentaerythritol monohydroxypentaacrylate, pentaerythritol triacrylate, ethoxylated trimethylolpropane triacrylate, 1,6-hexanediol-diacrylate, neopentyl glycoldiacrylate, pentaerythritol tetraacrylate, 1,2-butylene glycoldiacrylate, trimethylopropane ethoxylate tri(meth)acrylate, glyceryl propoxylate tri(meth)acrylate, trimethylolpropane tri(meth)acrylate, dipentaerythritol monohydroxy penta(meth)acrylate, tri(propyleneglycol) di(meth)acrylate, neopentylglycol propoxylate di(meth)acrylate, 1,4-butanediol di(meth)acrylate, polyethyleneglycol di(meth)acrylate, triethyleneglycol di(meth)acrylate, butylene glycol di(meth)acrylate and ethoxylated bisphenol A di(meth)acrylate. These monomers may be used each alone or a plurality of them may be copolymerized.

Particularly desirable (meth)acrylate ester monomers include those where the alcohol portion of the ester group contains 1-8 carbon atoms. For instance, 2-ethylhexyl (meth)acrylate, hydroxyethyl (meth)acrylate, cyclohexyl (meth)acrylate, ethyl (meth)acrylate, 1,3-butanedioldi(meth)acrylate (BDMA), butyl(meth)acrylate and methyl(meth)acrylate (MMA), are examples.

### Core-Shell Impact Modifier Component

The core shell impact modifier is desirably a graft copolymer of the “core shell”. The shell portion may be polymerized from methyl methacrylate and optionally other alkyl (meth)acrylates, such as ethyl, butyl (meth)acrylates or mixtures thereof. Up to 40 percent by weight or more of the shell monomers may be styrene, vinyl acetate, vinyl chloride, and the like. Additional core-shell graft copolymers useful in embodiments of the present invention are described in U.S. Pat. Nos. 3,984,497; 4,096,202; 4,034,013; 3,944,631; 4,306,040; 4,495,324; 4,304,709; and 4,536,436, the entireties of which are herein incorporated by reference. Examples of core-shell graft copolymers include, but are not limited to, “MBS” (methacrylate-butadiene-styrene) polymers, which are made by polymerizing methyl methacrylate (MMA) in the presence of polybutadiene or a polybutadiene copolymer rubber. The MBS graft copolymer resin generally has a styrene butadiene rubber core and a shell of acrylic polymer or copolymer. Examples of other useful core-shell graft copolymer resins include, ABS (acrylonitrile-butadiene-styrene), MABS (methacrylate-acrylonitrile-butadiene-styrene), ASA (acrylate-styrene-acrylonitrile), all acrylics, SA EPDM (styrene-acrylonitrile grafted onto elastomeric backbones of ethylene-propylene diene monomer), MAS (methacrylic-acrylic rubber styrene), and the like and mixtures thereof.

The core-shell impact modifier comprises a polymeric core and at least two polymeric layers surrounding the core, each layer having a different polymer composition from the other layer and, where at least one polymeric layer comprises a polymer that is a gradient polymer, the gradient polymer being a copolymer consisting of at least two different monomers (A) and (B) and having a gradient in repeat units arranged from mostly the monomer (A) to mostly the monomer (B) along the copolymer.

The core-shell impact modifier should comprise a particle having a particle size between 170 and 350 nm and a pH between 6 and 7.5 comprising one polymeric rubber core comprising at least partially crosslinked isoprene or butadiene and optionally styrene, and at least two polymeric layers wherein at least one polymeric layer is an outermost thermoplastic shell layer having a Tg greater than 25° C., each layer having a different polymer composition.

The core-shell impact modifier should comprise a polymeric rubber core is surrounded by a polymeric layer which is a polymeric core layer, the polymeric core layer having a glass transition temperature under 0° C. and a different polymer composition than the polymeric rubber core, where the polymeric core layer is a gradient zone.

The core-shell impact modifier should comprise at least one polymeric core layer and at least two polymeric shell layers, the polymeric core layer having a different composition than the polymeric shell layers, where each shell layer has a different polymer composition from the other shell layer, and where at least one polymeric shell layer is a gradient zone.

The core-shell impact modifier should comprise a polymeric rubber core with a glass transition temperature of less than 0°° C., such as less than about −10° C., desirably less than about −20° C. and advantageously less than about −25° C. and most advantageously less than about −40° C., such as between about −80° C. and about −40° C.

The core-shell impact modifier should comprise a polymeric rubber core constructed from any one or more of isoprene homopolymers or butadiene homopolymers, isoprene-butadiene copolymers, copolymers of isoprene with at most 98 percent by weight of a vinyl monomer and copolymers of butadiene with at most 98 percent by weight of a vinyl monomer. The vinyl monomer may be styrene, an alkylstyrene, acrylonitrile, an alkyl (meth)acrylate, or butadiene or isoprene. Desirably, the core should be constructed of one of polybutadiene, a copolymer of butadiene and styrene or a terpolymer of methyl methacrylate, butadiene and styrene.

In some embodiments, the core may also be covered by a core layer. By core layer is meant that the polymer composition of that core layer has a glass transition temperature (Tg) of less than 0° C., such as less than about −10° C., desirably less than about −20° C., and advantageously less than about −25° C. Desirably, the core layer is a gradient polymer.

The core-shell impact modifier should have more than one shell and desirably two shells. At least the outer shell, in contact with the thermoplastic matrix, has a Tg greater than about 25° C., such as greater than about 50° C.

The shell(s) of the core-shell impact modifier may be constructed from one or more of: styrene homopolymers, alkylstyrene homopolymers or methyl methacrylate homopolymers, or copolymers comprising at least 70 wt % of one of the above monomers and at least one comonomer chosen from the other above monomers, another alkyl (meth)acrylate, vinyl acetate and acrylonitrile. The shell may be functionalized for instance with anhydrides of unsaturated carboxylic acids, unsaturated carboxylic acids and unsaturated epoxides, for instance maleic anhydride, (meth)acrylic acid glycidyl methacrylate, hydroxyethyl methacrylate and alkyl (meth)acrylamides.

The gradient copolymer is created by occupying a position between two-layers, and in so doing creates a gradient zone in which at one side is richer in the monomer/polymer from the neighboring layer and at the other side is richer in the different monomer/polymer that forms the next layer. The gradient zone between the core and a shell or between two polymer shells may be produced for example by monomers that have different copolymerization parameters or by carrying out the reaction in a semi-continuous mode under starved feed conditions where the rate of the addition of the monomers is slower than is the rate of the reaction. The gradient polymer is however never the outermost layer of the core shell particle.

The monomers used to form the gradient polymer are chosen on function of the neighboring layers from the monomers cited with the core and the respective shells.

The young's modulus of the polymeric rubber core is always less than the modulus of the other polymeric layers. The young's modulus of the layer comprising the gradient polymer is always less than the modulus of the outer most layer.

The core-shell impact modifier should be in the form of fine particles having a rubber core and at least one thermoplastic shell, the particle size being generally less than 1 um and advantageously between 50 nm and 500 nm, preferably between 100 nm and 400 nm, and most preferably 150 nm and 350 nm, advantageously between 170 nm and 350 nm.

The core-shell impact modifier may be prepared by emulsion polymerization. For example, a suitable method is a two-stage polymerization technique in which the core and shell are produced in two sequential emulsion polymerization stages. If there are more shells another emulsion polymerization stage follows. A graft copolymer is obtained by graft-polymerizing a monomer or monomer mixture containing at least an aromatic vinyl, alkyl methacrylate or alkyl acrylate in the presence of a latex containing a butadiene-based rubber polymer. See U.S. Pat. Nos. 9,068,036 and 9,714,314 for more detailed information regarding the method of manufacturing such core-shell impact modifiers. Commercially available examples of such core-shell impact modifiers ae available commercially under the CLEARSTRENGTH tradename from Arkema Inc., Cary, NC. Arkema describes CLEARSTRENGTH XT100, for instance, as a methyl methacrylate-butadiene-styrene core-shell toughening agent, which is compatible with various monomers and easily dispersible in most liquid resin systems and exhibits a limited impact on their viscosity while providing a toughening effect over a wide range of service temperatures.

### Additional Tougheners

The inventive composition also includes at least one toughening component selected from “shell-less” cross-linked rubbery particulates, such as acrylonitrile-butadiene-styrene (ABS), a methacrylate-butadiene-styrene (MBS), and a methacrylate-acrylonitrile-butadiene-styrene (MABS). For example BLENDEX 338 is an ABS powder from GE Plastics. Another example is Kraton D 1155, a linear block copolymer based on styrene and butadiene with bound styrene of 40% mass. Kraton D 1155 is supplied as porous pellets dusted with amorphous silica. Another commercially available useful toughener is Hypro RLP 200X 168 VTM, a reactive liquid polybutadiene polymer terminated with methacrylate groups.

### Amines

Part A of the inventive compositions include at least one

amine that acts as a catalyst by accelerating or otherwise promoting curing of the present inventive compositions. The amines desirably are tertiary or sterically hindered. Suitable amines include, for example, tertiary amines represented by the formula NR3, where R is selected from alkyl, aryl, alkaryl, or aralkyl radicals, including C₁₋₁₀ alkyl, C₁₋₁₈ aryl, C₇₋₁₇ alkaryl, and C₇₋₁₅ aralkyl radicals. Suitable hindered amines also include primary or secondary amines, such as HNR₂ or H₂NR, where R is a C₄₋₁₀ alkyl. For example, alkyl groups such as tertiary butyl, or neopentyl, sterically shield the hydrogen bound to the nitrogen atom, and are suitable substituents in this component of the present invention. For either tertiary amines or secondary amines, the R groups may be linked so that the nitrogen is embedded within a cyclic structure.

Particularly useful amines for inclusion in the present inventive compositions include, for example, 1,8-diazabicyclo(5.4.0)undec-7-ene (DBU), 1,4-diazabicyclo(2.2.2)octane (DABCO), triethylamine, and substituted guanidines, such as tetramethylguanidine (TMG), dimethyl-p-toluidine (DMPT), dimethyl aniline, dihydroxyethyl aniline, dihydroxy ethyl p-toluidine, dimethyl-o-toluidine, dialkyl aniline, dialkyl toluidine and the like, acyl-thiourea, benzoyl-thiourea, and aryl-thiourea.

The amine may be present in an amount from about 0.01 percent by weight to about 5 percent by weight. Desirably, the amine is present in amounts from about 0.05 percent by weight to about 2 percent by weight. More desirably, the amine is present in amounts from about 0.3 percent by weight to about 0.7 percent by weight.

The inventive compositions may also desirably include an acid or acid ester. Suitable acids or acid esters include phosphoric acid or their derivatives, phosphate acid esters, and sulfonic acids or their derivatives. A preferred reactive acid component is a phosphate acid ester. The acid monomer is free-radical polymerizable acid monomers, such as ethylenically unsaturated mono or polycarboxylic acids, maleic acid and crotonic acid. Desirable ones include methacrylic acid (MAA) and acrylic acid. Their active acid component also modulates and decelerates the curing time of the thermoset composition. The amine component is necessary to cure the epoxy resin-containing Part (B), but without a phosphate ester component, the amine-induced curing process is generally too rapid for very large parts or laminates, making fabrication of the laminate too difficult. Additionally, excessively fast curing can cause trouble during curing, such as excessive heat from the exothermic curing reaction, and give inconsistent or uneven curing, and the resultant product may have undesirable physical characteristics, such as bubbling, brittleness, or less tensile strength than can be achieved when the curing is at a more measured rate. Suitable phosphate esters include those represented by the formula:

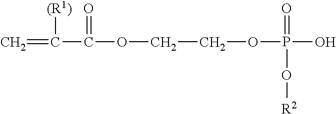

where R¹ is H or CH₃, and R² is H, or a radical represented by the structure:

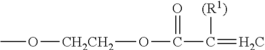

where R¹ is H or CH₃. A particularly useful phosphate ester is hydroxyl ethyl methacrylate (HEMA) phosphate ester, which is sold under the tradenames T-MULZ 1228 or HARCRYL 1228 or 1228M, each available from Harcross Chemicals, Kansas City, KS. Also included are structures with at least one strong acid “active hydrogen” group, or with at least one phosphonic acid active hydrogen group (R₁R₂POOH), such as hydroxyl ethyl diphosphonic acid, phosphonic acid, and derivatives, or oligomeric or polymeric structures with phosphonic acid functionality or similar acid strength functionality.

The Part (A) composition may also desirably include a free radical polymerization inhibitor, which prevents the Part (A) from reacting prematurely prior to mixing. Numerous suitable free-radical polymerization inhibitors are known in the art, and include quinones, hydroquinones, hydroxylamines, nitroxyl compounds, phenols, amines, arylamines, quinolones, phenothiazines, and the like. Particularly useful free radical inhibitors include hydroquinone, tertiary butylhydroquinone (TBHQ), methyl hydroquinone, hydroxyethylhydroquinone, phenothiazine, and NAUGARD-R (blend of N-alkyl substituted p-phenylene-diamines, from Crompton Corp.). One or more individual free radical inhibitor components may also be combined.

### Other Additives

Parts (A) and (B) may contain additional additives too, such as fillers, other core shell polymers, lubricants, thickeners, and coloring agents. The fillers provide bulk without sacrificing strength of the adhesive and can be selected from high or low density fillers. Also, certain fillers, such as silica, can confer rheological modification or small particle reinforcements. Commercially available examples include those under the Cab-O-Sil brand such as Cab-O-Sil 610 and those under the AEROSIL brand such as AEROSIL R8200. Of particular interest are low density fillers.

### Part (B)

### Epoxides

Useful epoxy components include, without limitation, cycloaliphatic epoxides, epoxy novolac resins, bisphenol-A epoxy resins, bisphenol-F epoxy resins, bisphenol-A epichlorohydrin based epoxy resin, alkyl epoxides, limonene dioxides, and polyepoxides. A desirable resin component is a cycloaliphatic epoxide sold by Dow Chemical under the brand name CYRACURE UVR-6110. UVR-6110 has the following structure:

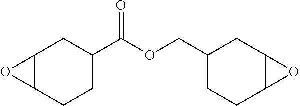 [SMILES: O=C(OCC1CCC2OC2C1)C1CCC2OC2C1]

Another suitable resin component is a bisphenol based liquid epoxy resin, such as those sold under the trade name “D. E.R. ‘by Dow Chemical. For description of these epoxy resins, see http://epoxy.dow.com/epoxy/products/prod/liquid.htm. Examples of “D.E.R.’ products that are suitable for this invention include D.E.R. 332 (diglycidyl ether of bisphenol-A); D.E.R. 330 (low viscosity, undiluted, bisphenol-A liquid epoxy resin); D.E.R. 383 (low viscosity, undiluted, bisphenol-A liquid epoxy resin); D.E.R. 354 (standard, bisphenol-F based liquid epoxy resin); D.E.R. 351 (low viscosity, liquid bisphenol-A/F resin blend); D.E.R. 352 (low viscosity, liquid bisphenol-A/F resin blend); D.E.R. 324 (aliphatic glycidyl ether reactive diluent, modified liquid epoxy resin); D.E.R. 323 (aliphatic glycidyl ether reactive diluent, modified liquid epoxy resin); D.E.R. 325 (aliphatic glycidyl ether reactive diluent, modified liquid epoxy resin); and D.E.R. 353 (aliphatic glycidyl ether reactive diluent, modified liquid epoxy resin). A different brand of a bisphenol based liquid epoxy resin suitable for use in this invention is EPON Resin 828, derived from bisphenol A and epichlorohydrin, and commercially available from Hexion Specialty Chemicals. See http://www.hexionchem.com/pds/E/EPONTM Resin 828.pdf.

Another suitable resin component is an epoxy novolac resin, which are products of epichlorohydrin and phenol formaldehyde novolac, and sold under the trade name D.E.N. by Dow Chemical. For a description of these epoxy resins, see http://epoxy.dow.com/epoxy/products/prod/nov.htm. Examples of “D.E.N.” products that are suitable for this invention include D.E.N. 431 (low viscosity semi-solid epoxy novolac resin); and D.E.N. 438 (semi-solid epoxy novolac resin). Other suitable epoxy resins include polyepoxides curable with catalyst or hardeners at ambient temperatures or at suitable elevated temperature. Examples of these polyepoxides include polyglycidyl and poly(3-methylglycidyl) ethers obtainable by reaction of a compound containing at least two free alcoholic hydroxyl and/or phenolic hydroxyl groups per molecule with the appropriate epichlorohydrin under alkaline conditions or, alternatively, in the presence of an acidic catalyst and Subsequent treatment with alkali. These ethers may be made from acyclic alcohols such as ethylene glycol, diethylene glycol, and higher poly(oxyethylene)glycols, propane-1,2-diol and poly(oxypropylene)glycols, propane 1,3-diol, butane-1,4-diol, poly(oxytetramethylene)glycols, pentane-1,5-diol, hexane-2,4,6-triol, glycerol. 1,1,1-trimethylolpropane, pentaerythritol, Sorbitol, and poly(epichlorohydrin); from cycloaliphatic alcohols, such as resorcinol, quinitol, bis(4-hydroxycyclohexyl)methane, 2.2-bis(4-hydroxycyclohexyl)propane, and 1,1-bis(hydroxymethyl)-cyclohex-3-ene; and from alcohols having aromatic nuclei, such as N, N-bis(2-hydroxyethyl)aniline and pip'-bis(2-hydroxyethylamino)diphenylmethane. Or they may be made from mononuclear phenols, such as resorcinol and hydroquinone, and from polynuclear phenols, such as bis(4-hydroxyphenyl)methane, 4,4′-dihydroxydiphenyl, bis(4-hydroxyphenyl)sulphone, 1.1.2.2-tetrabis(4-hydroxyphenyl)ethane, 2.2.-bis(4-hydroxyphenyl)propane (otherwise known as bisphenol A), 2.2-bis(3,5-dibromo-4-hydroxyphenyl)propane, and novolacs formed from aldehydes such as formaldehyde, acetaldehyde, chloral, and furfuraldehyde, with phenols such as phenol itself, and phenols substituted in the ring by chlorine atoms or by alkyl groups each containing up to nine carbon atoms, such as 4-chlorophenol, 2-methylphenol, and 4-t-butylphenol.

Poly (N-glycidyl) compounds include, for example, those obtained by dehydrochlorination of the reaction products of epichlorohydrin with amines containing at least two amino hydrogen atoms, such as aniline, n-butylamine, bis(4-aminophenyl)methane, and bis(4-methylaminophenyl)methane; triglycidyl isocyanurate; and N,N′-diglycidyl derivatives of cyclic alkylene ureas, such as ethyleneurea and 1,3-propyleneureas, and of hydantoins such as 5,5-dimethylhydantoin.

Epoxide resins having the 12-epoxide groups attached to different kinds of hetero atoms may be employed, e.g., the N,N,O-triglycidyl derivative of 4-aminophenol, the glycidyl ether-glycidyl ester of salicylic acid, N-glycidyl-N′-(2-glycidyloxypropyl)-5,5-dimethylhydantoin, and 2-glycidyloxyl, 3-bis(5,5-dimethyl-1-glycidylhydantoin-3-yl)propane.

Epoxides derived from oils, such as epoxidized soybean oil, epoxidized castor oil, and the like are also suitable. Epoxides derived from or capable of being derived from the per-acid oxidation of unsaturation are also suitable, including epoxidized liquid rubber.

### Peroxides

Benzoyl peroxide itself is a desirable choice for use in Part (B). Commercially available benzoyl peroxide-containing compositions may also be used. Benox-50 210 Blue (from 45 Syrgis Performance Initiators, Inc., Helena, AR), a peroxide paste believed to contain 49-50% benzoyl peroxide is one desirable choice. Benox-55 108 White, a peroxide paste believed to contain 54-56% benzoyl peroxide is another desirable choice. Still another desirable choice is Varox 50 ASNS from R.T. Vanderbilt, Norwalk, Conn., a peroxide paste which is believed to contain 55% benzoyl peroxide.

### Plasticizer

Plasticizers may be used in Part (B) of the two-part composition. As noted above, plasticizers may also be used in Part (A) as well. Plasticizers may be any liquid or soluble compound that assists with the flexibility of the reactive composition and/or may act as a carrier vehicle for other components of the composition. Examples include aromatic sulfonamides, aromatic phosphate esters, alkyl phosphate esters, dialkylether aromatic esters, polymeric plasticizers, dialkylether diesters, polyglycol diesters, tricarboxylic esters, polyester resins, aromatic diesters, aromatic triesters (trimellitates), aliphatic diesters, epoxidized esters, chlorinated hydrocarbons, aromatic oils, alkylether monoesters, naphthenic oils, alkyl monoesters, paraffinic oils, silicone oils, di-n-butyl phthalate, diisobutyl phthalate, di-n-hexyl phthalate, di-n-hepytl phthalate, di-2-ethylhexyl phthalate, 7C,-9C-phthalate (linear and branched), diisoctyl phthalate, linear 6C-10C phthalate, diisononyl phthalate,, linear 7C-10C phthalate, diisodecyl phthalate, linear 9C-11C phthalate, diundecyl phthalate, diisodecyl glutarate, di-2-ethylhexyl adipate, di-2-ethylhexyl azelate, di-2-ethylhexyl sebacate, di-n-butyl sebacate, diisodecyl adipate, triethylene glycol caprate caprylate, triethylene glycol 2-ethylhexanote, dibutoxyethyl adipate, dibutoxy-ethoxyethyl adipate, dibutoxyethoxyethyl formal, dibutoxy-ethoxyethyl sebacate, tri-2-ethylhexyl trimellitate, tri-(7C-9C (linear)) trimellitate, tri-(8C-10C (linear)) trimellitate, triethyl phosphate, triisopropyl phenyl phosphate, tributyl phosphate, 2-ethylhexyl diphenyl phosphate, trioctyl phosphate, isodecyl diphenyl phosphate triphenyl phosphate, triaryl phosphate synthetic, tributoxyethyl phosphate, tris(-chloro-ethyl)phosphate, butylphenyl diphenyl phosphate, chlorinated organic phosphate, cresyl diphenyl phosphate, tris(dichloropropyl)phosphate, isopropylphenyl diphenyl phosphate, trixylenyl phosphate, tricresyl phosphate, diphenyl octyl phosphate.

### Block Copolymers

When used, the block copolymer may be any block copolymer capable of contributing to the physical properties desired for the disclosed composition. The block copolymer may be used in either Part (A) or Part (B).

The block copolymer rubber may be constructed using blocks of either butadiene or isoprene with styrene (for example, SBS, SIS, SEBS and SB), commercial examples of which are available from Shell Chemical Co. as KRATON D-1116 and other KRATON D-grade elastomers, as well as elastomers from Dexco such as VECTOR 2411IP.

Other elastomers with a Tg below about 25° C., which are soluble in methacrylate/acrylate monomers, can be used in place of the polychloroprene and/or the block copolymer rubbers. Examples of such are homopolymer of epichlorohydrin and its copolymers with ethylene oxide, available from Zeon Chemicals as HYDRIN, acrylate rubber pellets, available from Zeon as HYTEMP, polyisoprene rubber, polybutadiene rubber, nitrile rubber, and SBR rubber (random copolymer of butadiene and styrene).

Still other block copolymers may be a styrene maleic anhydride copolymer, represented by the formula:

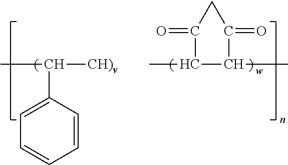

Styrene maleic anhydride copolymers are well known and some of which are available commercially from Sartomer Company, Inc., Exton, Pa. under the trade name SMA EFSO, for example. Styrene maleic anhydride copolymers represent the copolymerization product of styrene and maleic anhydride and are characterized by alternating blocks of styrene and maleic anhydride moieties.

Amphiphilic block copolymers may be particularly desirable. Arkema offers for sale commercially an amphiphilic block copolymer under the trademark NANOSTRENGTH. Such block copolymers are currently available in two versions: SBM and MAM. The SBM copolymer is reportedly made of polystyrene, 1,4-polybutadiene and syndiotactic poly(methyl methacrylate).

In addition, a polymer material constructed from polymethylmethacrylate (“PMMA”) and polybutylacrylate (“PB”) may be used too. Polymer materials within this class are referred to as polymethylmethacrylate-block-polybutylacrylate-block polymethylmethacrylate copolymers (“MAM”). As reported by Arkema, MAM is a triblock copolymer, consisting of about 70% PMMA and 30% PB. MAM is constructed from distinct segments, which provides for the ability to self-assemble at the molecular scale. That is, M confers hardness to the polymer and A confers elastomeric properties to the polymer. A hard polymer segment tends to be soluble in (meth)acrylates, whereas the elastomeric segments provide toughness to the polymeric (meth)acrylate, which forms upon cure. MAM also reinforces mechanical properties, without compromising inherent physical properties. MAM is commercially available under the tradename NANOSTRENGTH, at present under several different grades-i.e., E-21 and M-52N.

Arkema promotes the NANOSTRENGTH product line as an acrylic block copolymer that is miscible with many polymers, most of which according to the manufacturer are major industrial epoxy resins. See also U.S. Pat. No. 6, 894, 113, where in its abstract the '113 patent speaks to a thermoset material with improved impact resistance. The impact resistance is derived from 1 to 80% of an impact modifier comprising at least one copolymer comprising S-B-M, B-M and M-B-M blocks, where each block is connected to the other by a covalent bond or of an intermediary connected to one of the blocks by a covalent bond and to the other block by another covalent bond, M is a PMMA homopolymer or a copolymer comprising at least 50% by weight of methyl methacrylate, B is incompatible with the thermoset resin and with the M block and its glass transition temperature Tg is less than the operating temperature of the thermoset material, and S is incompatible with the thermoset resin, the B block and the M block and its Tg or its melting temperature is greater than the Tg of B.

Another commercially available example of an amphiphilic block copolymer is a polyether block copolymer known to the trade as FORTEGRA 100, from Dow Chemical Co. Dow describes FORTEGRA 100 as a low viscosity toughening agent designed for use as a high efficiency second phase, in amine cured epoxy systems. FORTEGRA 100 is reported to provide improved toughness without significantly affecting the viscosity, glass transition temperature, corrosion resistance, cure rate or chemical resistance of the final coating or composition. FORTEGRA 100 is also reported to be useful for formulation into standard bisphenol A and bisphenol F epoxy systems as it does not participate in the epoxy cure reaction. As a second phase toughening agent, FORTEGRA 100 is promoted as being effective when formulated at a specific volume fraction of the finish film or part, typically 3% to 8% by dry volume is said to achieve the toughening effect.

Additional block copolymers include those which comprise both hydrophobic and hydrophilic segments, or portions of the general formula:

—[(R¹)ᵥ—(R²)_{w}lₙ—

Where here R¹ is independently a hydrophobic olefin, such as ethylene, propylene, 1-butene, 1-hexene, 3-methyl-1-pentene, or 4-methyl-1-pentene or a polymerizable hydrophobic aromatic hydrocarbon such as styrene; each R² is a hydrophilic acid anhydride, such as maleic anhydride; v is from 1 to 12; w is from 1 to 6; and n is from 1 to 50.

### Other Additives

Parts (A) and (B) may contain additional additives, such as fillers, lubricants, thickeners, and coloring agents. The fillers provide bulk without sacrificing strength of the adhesive and can be selected from high or low density fillers.

### Packaging

Each of Parts (A) and (B) are packaged in separate containers, such as bottles, cans, tubes, or drums. Parts (A) and (B) are mixed in a by weight ratio of about 3 to 50 parts (A) to one part (B). Preferably, the by weight ratio of Parts (A) and (B) is about 5 to 20 Parts (A) to one Part (B).

The mixing of the two parts can employ a mixing nozzle, which has fluid inputs for the two components, performs a suitable mixing operation, and dispenses the adhesive mixture directly onto the surface to be bonded. An example of a commercially available mixing and dispensing device is MIXPAC®, available from ConProTec, Salem, NH. The two parts can also be mixed manually in a bowl, bucket, or the like, but the operator needs to ensure that the mixing is thorough. As an aid to ensuring that mixing is complete, each part can be formulated with a dye or pigment, so that after mixing, a third color is formed. For example, one part may have a yellow dye, the other part may have a blue dye, so that after mixing, the complete adhesive composition will be green.

By the term “curing” is meant that the chemical reaction converting the fluid mix to the solid bond of this invention. The curing process of this composition is exothermic, and may reach a temperature of about 120° C. or so, when a large bead of adhesive is used.

### Examples

Loctite HHD8540 is a 2-part, commercially available structural adhesive, which is used as a comparative for the inventive compositions. Each of the inventive examples below used the methylmethacrylate-butadiene-styrene core-shell toughening additive of the invention either as a replacement for one or more of the toughening agents in Loctite HHD8540 composition; or in addition to one or more of the toughening agents in the Loctite HHD8540 composition, as indicated in the Tables below.

Part (B) of the commercially available composition Loctite HHD8540 was kept constant for all compositions as shown in each of the inventive Compositions set for the in the Tables below.

The mixing ratio on a by weight basis for Part (A) to Part (B) was 10:1. The mixed products were cured at 45° C. for 20 min and then followed at room temperature for 24 hours before any testing was performed.

### Testing

For the Izod impact resistance, double sized aluminum lapshears were used and testing was conducted using ASTM D 6110-18.

For side-impact resistance, grit blasted mild steel (GBMS) lapshears were used having a 5-mil gap. Side testing was conducted using a drop-tower style impact tester and recorded by an instrumented tup. A known mass is dropped at a specified velocity edgewise onto a bonded lap-shear assembly. The force required to rupture the adhesive bond is recorded by an instrumented tup. The side impact test was based on the GM9751P Rev. August 2014 General Motors Engineering Standards Side Impact Test.

All compositions tested in the Examples used the following Part (B) composition.

Part (B) Used for All Examples

| Components | Amount |
|---|---|
| Part (B) | (grams) |
| Pluracol V 10-polyoxyalkylene polyol | 10 |
| (Thickener) | |
| Benzoflex 2088 (Plasticizer) | 20.4 |
| Dibenzoyl peroxide 75 | 37 |
| (Part of Curative Package) | |
| Bisphenol A Epichlorhydrin epoxy resin | 21 |
| Econopoly 2 N 1 polyethylene 1.045 wax- | 11.5 |
| filler' sold by Lawter International | |
| Vossen Blau 750 LS Pigment | 0.1 |

### Example 1

Table 1 shows a commercially available prior art composition, as well as inventive Compositions 1-4. Each of the inventive compositions contain the core-shell impact modifier in addition.

TABLE 1

| | Loctite | | | | |
|---|---|---|---|---|---|
| | HHD8540 | | | | |
| Component | Part A³ | Composition 1 | Composition 2 | Composition 3 | Composition 4 |
| Part A | (gram) | (gram) | (gram) | (gram) | (gram) |
| Methyl methacrylate | 45.95 | 46.35 | 46.35 | 46.35 | 46.35 |
| EDTA tetrasodium | 0.10 | 0.10 | 0.10 | 0.10 | 0.10 |
| salt 4H2O (Part of | | | | | |
| Stabilizer Package) | | | | | |
| Naphthoquinone | 0.05 | 0.05 | 0.05 | 0.05 | 0.05 |
| (Stabilizer) | | | | | |
| Triphenylphosphine | 0.50 | 0.50 | 0.50 | 0.50 | 0.50 |
| (Curative) | | | | | |
| p- | 1.50 | 1.50 | 1.50 | 1.50 | 1.50 |
| Tolyldiethanolamine | | | | | |
| (Curative) | | | | | |
| Blendex 338⁴ | 4.50 | 4.50 | 4.50 | 4.50 | 4.50 |
| Kraton D 1155⁵ | 22.00 | — | — | — | 22.00 |
| Methyl methacrylate- | — | 22.00 | 22.00 | 22.00 | 13.00 |
| butadiene-styrene | | | | | |
| core-shell¹ | | | | | |
| Hypro RLP 2000 | 13.00 | 13.00 | — | — | — |
| X 168 VTB² | | | | | |
| BRC-641D⁶ | — | — | 13.00 | — | — |
| BR-5541M⁷ | — | — | — | 13.00 | — |
| IGI 1239 A⁸ | 0.40 | — | — | — | — |
| Methylacrylic acid | 10.00 | 10.00 | 10.00 | 10.00 | 10.00 |
| stab. (Adhesion | | | | | |
| Promoter) | | | | | |
| Harcryl 1228 | 1.00 | 1.00 | 1.00 | 1.00 | 1.00 |
| (Adhesion Promoter) | | | | | |
| Aerosil 200 | 1.00 | 1.00 | 1.00 | 1.00 | 1.00 |
| (Rheology Modifier) | | | | | |
| Total | 100.00 | 100.00 | 100.00 | 100.00 | 100.00 |

¹ClearStrength XT 100 available from Arkema Inc., Cary, NC.
²Hypro ™ Reactive Liquid Polymers Methacrylate Terminated Polybutadiene from CVC Thermoset Specialties, Moorestown, NJ;
³Comparative Example—Commercially available product from the Henkel Corporation
⁴Blendex 338 acrylonitrile-butadiene styrene, available from Crompton Corp.
⁵Kraton D 1155 linear block copolymer of butadiene-styrene solid rubber particles, available from Kraton Corp.
⁶BRC-641D Polybutadiene urethane acrylate oligomer, available from Dymax Corp.
⁷BR-5541M-difunctional flexible aliphatic polyether urethane methacrylate diluted in 20% isobornyl acrylate (IBOA), available from Dymax Corp.
⁸IGI 1239 paraffin wax

Each of the compositions in Table 1 were tested for Izod Impact resistance (ASTM D 6110-18).

Table 2 shows test results. Compositions 1-3 incorporated the core-shell component, which is methacrylate miscible, in combination with another toughener component. As seen from the test values, inventive compositions 1-4 showed comparable or better impact resistance than the commercially available compositions containing toughening agents, Kraton D 1155 and Hypro RLP 2000 X 168 VTB, which are not miscible in methyl methacrylate.

TABLE 2
Izod Impact Resistance Test Results

| | Izod Impact | |
|---|---|---|
| Composition | Resistance | Toughening agents Present |
| Loctite HHD8540 | 8.76 | Kraton D 1155 + Hypro RLP |
| Comparative Prior Art | | 2000 X 168 VTB |
| Inventive Composition 1 | 8.39 | Clearstrength ® XT100 + |
| X412806-1 | | Hypro RLP 2000 X 168 VTB |
| Inventive Composition 2 | 7.30 | Clearstrength ® XT100 + |
| (X412806-2) | | BRC-641D |
| Inventive Composition 3 | 6.90 | Clearstrength ® XT100 + |
| (X412806-3) | | BR-5541M |
| Inventive Composition 4 | 9.58 | Kraton D 1155 + |
| (X412806-4) | | Clearstrength ® XT100 |

### Example 2

TABLE 3

| Components | Composition 5 | Composition 6 |
|---|---|---|
| Part A | (gram) | (gram) |
| Methyl methacrylate | 45.95 | 39.06 |
| EDTA tetrasodium salt 4H2O | 0.10 | 0.09 |
| (Part of Stabilizer Package) | | |
| Naphthoquinone | 0.05 | 0.04 |
| (Part of Stabilizer Package) | | |
| Triphenylphosphine | 0.50 | 0.43 |
| (Part of Curative package) | | |
| p-Tolyldiethanolamine | 1.50 | 1.28 |
| (Part of Curative package) | | |
| Blendex 338 | 4.50 | 3.83 |
| Kraton D 1155 | 22.00 | 18.70 |
| Hypro 2000 X168LC VTB | — | 11.05 |
| Methyl methacrylate-butadiene- | 13.00 | 15.00 |
| styrene core-shell* (Clearstrength | | |
| XT 100 | | |
| IGI 1239 A | 0.4 | 0.34 |
| Methylacrylic acid (Adhesion | 10.00 | 8.50 |
| promoter) | | |
| Harcryl 1228 (Adhesion promoter) | 1.00 | 0.85 |
| Aerosil 200 (Rheology modifier) | 1.00 | 0.85 |
| Total | 100.00 | 100.00 |

Each of inventive compositions 4 and 5 were formulated as shown above in Table 3 and side impact testing was performed, the results being shown in Table 4.

As shown in Table 4, the incorporation of the shell-core toughening component in amounts of 13-15 parts by weight, along with one or more non-miscible tougheners provided side impact results comparable to the commercially available Henkel compositions which contained only non-miscible tougheners.

TABLE 4
Side Impact Resistance Test Results

| | Side Impact | |
|---|---|---|
| | Resistance | |
| | Total Energy | Toughening |
| Composition | Absorbed (J) | agents Present |
| Loctite HHD8540 | 11.5 | Kraton D 1155 + Hypro RLP |
| Comparative | | 2000 X 168 VTB |
| Inventive | 10.5 | Kraton D 1155 + |
| Composition 5 | | Clearstrength ® XT100 |
| (X412809-4) | | |
| Inventive | 12.9 | Kraton D 1155 + Hypro RLP |
| Composition 6 | | 2000 X 168 VTB + |
| (X412809-5) | | Clearstrength ® XT100 |

### Example 3

TABLE 5

| Composition | Composition 7 |
|---|---|
| Part A | (gram) |
| Methyl methacrylate | 39.06 |
| EDTA tetrasodium salt 4H2O (Part | 0.09 |
| of Stabilizer Package) | |
| Naphthoquinone (Part of Stabilizer Package) | 0.04 |
| Triphenylphosphine (Part of Curative package) | 0.43 |
| p-Tolyldiethanolamine (Part of | 1.28 |
| Curative package) | |
| Blendex 338 | 3.83 |
| Kraton D 1155 | 18.70 |
| Hypro 1300X33LC VTBNX | 11.05 |
| Methyl Methacrylate-butadiene- | |
| styrene core-shell* (Clearstrength | |
| XT 100) | 15.00 |
| IGI 1239 A | 0.34 |
| Methylacrylic acid (Adhesion | 8.50 |
| Promoter) | |
| Harcryl 1228 (Adhesion Promoter) | 0.85 |
| Aerosil 200 (Rheology Modifier) | 0.85 |
| Total | 100.00 |

Composition 7, in Table 5 above, contained 15 parts by weight core-shell component in addition to Kraton D 1155 and Hypro 1300X33LC VTBNX, both of the latter being non-miscible toughening components.

The results of the side impact testing surprisingly showed 53 increase in impact resistance with the combination of Kraton D 1155 and Hypro 1300X33LC VTBNX and the core-shell components.

TABLE 6
Side Impact Resistance Test Results

| | Side Impact | |
|---|---|---|
| | Resistance Total | |
| | Energy | Toughening |
| Composition | Absorbed (J) | agents Present |
| HHD8540 Comparative | 6.5 | Kraton D 1155 + Hypro |
| Prior Art (X412809-2) | | 1300X33LC VTBNX |
| Inventive | 11.4 | Kraton D 1155 + Hypro |
| Composition 7 | | 1300X33LC VTBNX + |
| (X412809-6) | | Clearstrength ® XT100 |

### Example 4

TABLE 7

| | Inventive |
|---|---|
| | Composition 8 |
| Component | (gram) |
| Methyl Methacrylate | 39.06 |
| EDTA tetrasodium salt 4H2O | 0.09 |
| (Part of Stabilizer Package) | |
| Naphthoquinone | 0.04 |
| (Part of Stabilizer Package) | |
| Triphenylphosphine | 0.43 |
| (Part of Curative Package) | |
| p-Tolyldiethanolamine | 1.28 |
| (Part of Curative Package) | |
| Blendex 338 | 3.83 |
| Kraton D 1155 | 18.70 |
| Hypro 1300X43LC VTBNX | 11.05 |
| Methyl Methacrylate-butadiene-styrene | 15.00 |
| core-shell* (Clearstrength XT 100) | |
| IGI 1239 A | 0.34 |
| Methylacrylic acid (stabilizer) | 8.50 |
| Harcryl 1228 (Adhesion Promoter) | 0.85 |
| Aerosil 200 (Rheology Modifier) | 0.85 |
| Total | 100.00 |

Similar to Example 3, inventive composition 8 also contained a combination of the core-shell component, Kraton D 1155 and Hypro 1300X43LC VTBNX. Side impact testing results (Table 8) demonstrated approximately 54 increase in side impact resistance.

TABLE 8
Side Impact Resistance Test Results

| | Side Impact | |
|---|---|---|
| | Resistance Total | Toughening |
| Compositions | Energy Absorbed (J) | agents Present |
| HHD5840 | 4.9 | Kraton D 1155 + Hypro |
| Comparative | | 1300X43LC VTBNX |
| Inventive | 10.3 | Kraton D 1155 + Hypro |
| Composition 8 | | 1300X43LC VTBNX + |
| | | Clearstrength ® XT100 |

### Example 5

TABLE 9

| | Inventive | Inventive |
|---|---|---|
| | composition 9 | composition 10 |
| Composition | (gram) | (gram) |
| Methyl methacrylate | 46.45 | 50.72 |
| EDTA tetrasodium salt 4H2O | 0.10 | 0.11 |
| (Part of Stabilizer Package) | | |
| Naphthoquinone (Part of | 0.05 | 0.05 |
| Stabilizer Package) | | |
| Triphenylphosphine | 0.50 | 0.55 |
| (Part of Curative Package) | | |
| p-Tolyldiethanolamine | 1.5 | 1.64 |
| (Part of Curative Package) | | |
| Blendex 338 | 4.50 | 4.92 |
| Kraton D 1155 | | 22.00 |
| Clearstrength XT 100 | 22.00 | 6.45 |
| Hypro RLP 2000 X 1 | 13.00 | |
| Triphenylphosphine 68 VTB | | |
| IGI 1239 A | 0.4 | 0.44 |
| Methylacrylic acid (Stabilizer) | 10 | 10.93 |
| Harcryl 1228 (Adhesion Promoter) | 1 | 1.09 |
| Aerosil 200 (Rheology Modifier) | 0.5 | 1.09 |
| Total | 100.00 | 100.00 |

Inventive composition 9 contains the core-shell toughening component in amounts of about 22 parts by weight in combination with Blendex 338 (ABS rubber particles) and 13 parts by weight Hypro RLP 2000 X 1. Inventive composition 10 contained the core-shell toughening component in combination with about 6.45 parts by weight in combination with an amount of 4.92 parts by weight of Blendex 338 and 22 parts by weight of Kraton D 1155.

The side impact tests for compositions 9 and 10 show an increase of approximately 41% each in side impact resistance, as compared to the commercially available Henkel product which contained only non-miscible toughness.

TABLE 10
Side Impact Resistance Test Results

| | Side Impact | |
|---|---|---|
| | Resistance | |
| | Total Energy | Toughening |
| Compositions | Absorbed (J) | agents Present |
| Comparative | 10.3 | Kraton D 1155 + Hypro |
| Loctite HHD8540 | | RLP 2000 X 168 VTB |
| Inventive | 17.7 | Hypro RLP 2000 X 168 |
| Composition 9 | | VTB + Clearstrength ® |
| | | XT100 |
| Inventive | 17.7 | Kraton D 1155 + |
| Composition 10 | | Clearstrength ® XT100 |

1. An adhesive composition comprising:
a) a first part comprising
i. a (meth)acrylate component;
ii. about 10% to about 25% by weight of the total composition of a core-shell impact modifier comprising a polymeric core and at least two polymeric layers surrounding the core, each layer having a different polymer composition from the other layer and, wherein at least one polymeric layer comprises a polymer that is a gradient polymer, the gradient polymer being a copolymer consisting of at least two different monomers (A) and (B) and having a gradient in repeat units arranged from mostly the monomer (A) to mostly the monomer (B) along the copolymer;
iii. about 10% to about 25% by weight of the total composition of a toughening component selected from the group consisting of polybutadiene rubber particles (Kraton D), a liquid methacrylate-terminated polybutadiene polymer (Hypro RLP) and combinations thereof;
iv. an amine; and
b) a second part comprising:
i. an epoxy; and
ii. a peroxide;
wherein upon cure the composition exhibits at least a 50% increase in side impact strength as compared to the substantially same composition without the impact modifier.

2. The composition of claim 1, wherein upon cure the composition exhibits at least a 60% increase in side impact strength as compared to the substantially same composition without the impact modifier.

3. The adhesive composition of claim 1, wherein the core-shell impact modifier comprises a particle having a particle size between 170 and 350 nm comprising one polymeric rubber core comprising at least partially crosslinked isoprene or butadiene and optionally styrene, and at least two polymeric layers wherein at least one polymeric layer is an outermost thermoplastic shell layer having a Tg greater than 25° C., each layer having a different polymer composition.

4. The composition of claim 1, wherein the core-shell impact modifier comprises a polymeric rubber core is surrounded by a polymeric layer which is a polymeric core layer, the polymeric core layer having a glass transition temperature under 0° C. and a different polymer composition than the polymeric rubber core, wherein said polymeric core layer is said gradient zone.

5. The composition of claim 1, wherein the core-shell impact modifier comprises a polymeric rubber core with a glass transition temperature of less than about −40° C.

6. The composition of claim 1, wherein the core-shell impact modifier comprises a polymeric rubber core with a glass transition temperature of between about −80° C. and about −40° C.

7. The composition of claim 1, wherein the core-shell impact modifier comprises a polymeric rubber core constructed from polybutadiene.

8. The composition of claim 1, wherein the core-shell impact modifier comprises a polymeric rubber core constructed from butadiene and styrene.

9. The composition of claim 1, wherein the (meth)acrylic component of part (a) is selected from the group consisting of methyl (meth)acrylate, (meth)acrylic acid, ethyl (meth)acrylate, n-propyl (meth)acrylate, isopropyl (meth)acrylate, n-butyl (meth)acrylate, isobutyl (meth)acrylate, tert-butyl (meth)acrylate, n-pentyl (meth)acrylate, n-hexyl (meth) acrylate, cyclohexyl (meth)acrylate, n-heptyl (meth)acrylate, n-octyl (meth)acrylate, 2-ethylhexyl (meth)acrylate, nonyl (meth)acrylate, decyl (meth)acrylate, dodecyl (meth)acrylate, phenyl (meth)acrylate, tolyl (meth)acrylate, benzyl (meth)acrylate, 2-methoxyethyl (meth)acrylate, 3-methoxybutyl (meth)acrylate, 2-hydroxyethyl (meth)acrylate, 2-hydroxypropyl (meth)acrylate, stearyl (meth)acrylate, glycidyl (meth)acrylate, 2-aminoethyl (meth)acrylate, 2-(meth)acryloyloxypropyl trimethoxysilane, (meth)acrylic acid-ethylene oxide adduct, trifluoromethylmethyl (meth)acrylate, acrylate, 2-perfluorohexylethyl (meth)acrylate, 2-perfluorodecylethyl (meth)acrylate, 2-perfluorohexadecylethyl (meth)acrylate, ethoxylated trimethylolpropane triacrylate, trimethylol propane trimethacrylate, dipentaerythritol monohydroxypentacrylate, pentaerythritol triacrylate, ethoxylated trimethylolpropane triacrylate, 1,6-hexanediol-diacrylate, neopentylglycoldiacrylate, pentaerythritol tetraacrylate, 1,2-butylene glycoldiacrylate, trimethylolpropane ethoxylate tri(meth)acrylate, glyceryl propoxylate tri(meth)acrylate, trimethylolpropane tri(meth)acrylate, dipentaerythritol monohydroxy penta(meth)acrylate, tri(propylene glycol) di(meth)acrylate, neopentylglycol propoxylate di(meth)acrylate, 1,4-butanedioldi(meth)acrylate, polyethyleneglycol di(meth)acrylate, triethyleneglycol di(meth)acrylate, butyleneglycol di(meth)acrylate, ethoxylated bisphenol A di(meth)acrylate, and combinations thereof.

10. The composition of claim 1, wherein the toughening component comprises polybutadiene rubber particles and a liquid methacrylate-terminated polybutadiene polymer.

11. The composition of claim 1, wherein the amine is selected from the group consisting of 1,8-diazabicyclo(5.4.0)undec-7-ene, 1,4-diazabicyclo(2.2.2)octane, triethylamine, tetramethylguanidine, dimethyl-p-toluidine, dimethyl aniline, dihydroxyethyl aniline, dihydroxyethyl p-toluidine, dimethyl-o-toluidine, dimethyl aniline, and benzoyl thiourea, trialkyl amine, tributyl amine, dihydro pyridine, phenyl dihydropyridine, dihydropyridine derivatives, aldehyde condensation products of alkyl, aromatic, hetero-cyclic amines, and combinations thereof.

12. The composition of claim 1, further including a (meth)acrylate-terminated polyurethane component.

13. The composition of claim 1, further including a triaryl or alkylaryl phosphine.

14. The composition of claim 13, wherein the phosphine is selected from the group consisting of tri(o-tolyl)phosphine, tris(4-methoxyphenyl)phosphine, diphenyl(p-tolyl)phosphine, Diphenyl(o-tolyl)phosphine, tris(o-methoxyphenyl)phosphine, tri(p-tolyl)phosphine, diphenyl(2-methoxyphenyl)phosphine, tris(3,5-dimethylphenyl)phosphine, and triphenylphosphine.

15. The composition of claim 1, wherein the first part and the second part are in a by weight ratio of first part (a) to second part (b) of about 10 to about 1.

16. The composition of claim 1, further including a free radical stabilizer selected from the group consisting of quinones, hydroquinones, and combinations thereof.

17. The composition of claim 1, further including a free radical stabilizer selected from the group consisting of hydroquinone, tertiary butylhydroquinone, phenothiazine, methyl hydroquinone, hydroxyethylhydroquinone, N-alkyl substituted p-phenylenediamines, and combinations thereof.

18. The composition of claim 1, further comprising a component selected from the group consisting of plasticizers, fillers, block copolymers, thixotropic agents, rheology modifiers, viscosity modifiers, adhesion promoters, diluents, monomers, oligomers and combinations thereof.

19. A method of bonding a first surface to a second surface, comprising:
providing a two-part adhesive composition of claim 1, providing a first surface to be bonded and a second surface to be bonded,
dispensing with mixing the two-part adhesive composition onto at least one of the first surface or the second surface,
mating the first surface and the second surface with the adhesive composition between the mated first surface and the second surface, and
forming an adhesive bond therebetween.

20. The method of claim 19, wherein the first part and second are mixed in a by weight ratio of the first part (a) to the second part (b) is about 10 to about 1.

21. An adhesive composition comprising the reaction product of:
a) a first part comprising
i. a (meth)acrylate component;
ii. about 10% to about 25% by weight of the total composition of a core-shell impact modifier comprising a polymeric core and at least two polymeric layers surrounding the core, each layer having a different polymer composition from the other layer and, wherein at least one polymeric layer comprises a polymer that is a gradient polymer, the gradient polymer being a copolymer consisting of at least two different monomers (A) and (B) and having a gradient in repeat units arranged from mostly the monomer (A) to mostly the monomer (B) along the copolymer;
iii. about 10% to about 25% by weight of the total composition of a toughening component selected from the group consisting of polybutadiene rubber particles, a liquid methacrylate-terminated polybutadiene polymer and combinations thereof; and
iv. an amine; and
b) a second part comprising:
i. an epoxy; and
ii. a peroxide;
wherein upon cure the composition exhibits at least a 50 increase in side impact strength as compared to the substantially same composition without the impact modifier.
